(19) United States
(12) Patent Application Publication
(10) Pub. No.: US 2026/0305637 A1
(43) Pub. Date: Oct. 8, 2026

(54) METHOD OF PREPARING IMPROVED PASTA FILATA CHEESE AND SAID PASTA FILATA CHEESE

(71) Applicant: Arla Foods amba, Viby J (DK)

(72) Inventors: Karen Hjorth Pedersen, Viby J (DK); Søren Kristian Lillevang, Viby J (DK); Mads Kristian Honoré Aamann, Viby J (DK)

(21) Appl. No.: 19/483,444

(22) PCT Filed: Jun. 3, 2024
(86) PCT No.: PCT/EP2024/065184

§ 371 Date: Nov. 11, 2025

(30) Foreign Application Priority Data
Jun. 2, 2023 (EP) 23177077.7

(51) Int. Cl. A23C 19/068; A23C 9/142; A23C 19/05; A23C 19/09

(52) U.S. Cl. CPC A23C 19/0684; A23C 9/1422; A23C 19/05; A23C 19/0921

(57) ABSTRACT

The present invention relates to a method of preparing a pasta filata cheese and the pasta filata cheese obtained. In particular, the present invention relates to a method of preparing a pasta filata cheese without a maturation step where ultrafiltration is used to remove calcium from the milk derived feed used for preparing the pasta filata cheese. The milk derived feed having some calcium removed is used for preparing cheese curds and calcium is added to the calcium depleted cheese curds before being processed into a pasta filata cheese.

### TECHNICAL FIELD OF THE INVENTION

The present invention relates to a method of preparing a pasta filata cheese and the pasta filata cheese obtained. In particular the present invention relates to a method of preparing a pasta filata cheese without maturation where calcium, by ultrafiltration, is removed from a milk derived feed used for preparing the pasta filata cheese. Said calcium removed milk derived feed is used for preparing cheese curd and calcium is subsequently added to the calcium depleted cheese curd before being processed into a pasta filata cheese.

### BACKGROUND OF THE INVENTION

Pasta filata cheeses, such as for example mozzarella, are widely used in many food application such as topping on pizza.

Pasta filata cheeses are typically prepared by adding an acidifying agent and a starter culture to milk, such that the proteins in the milk denature and coagulate to form solid curd. The curd is cut into smaller pieces and whey is removed from the curd. The curd is then heated, stretched and shaped into form before being matured 2-3 weeks. The maturation step is important. For example, the maturation step is important because it takes some time for the action of the proteolytic degradation of the proteins. In addition, the calcium content plays a role in the functionalities obtained in a pasta filata cheese. Most of the calcium present immediately after the cheese is obtained is bound to the proteins in a protein matrix. However, in order to obtain good functional properties of the mozzarella cheese, it is important to have equilibrium between bound and unbound calcium. During the maturation step bound calcium is released from the degraded proteins and equilibrium between bound and unbound calcium is obtained. If the calcium content is too high, the melting properties, browning and other functional properties of the mozzarella is poor.

However, it has been found that pasta filata cheese may be prepared without a time consuming maturation step by making the pasta filata cheese from an UF retentate of milk that has been ultrafiltered to increase the protein content and reduce the calcium content in the UF retentate. Coagulation enzymes is added to the UF retentate to obtain cheese curd and after separation of the whey, the curd can by heating and stretching be processed into a pasta filata cheese within 24 hours. However, in such rapid method of preparing pasta filata cheese, calcium will be removed to increase the functional properties of the pasta filata cheese.

Calcium plays an important role in manufacturing of pasta filata cheese and also in the functionality of the cheese. For example, it is known that by lowering the calcium content in a dairy feed material used for preparing the pasta filata cheese, the pasta filata cheese will obtain improved melting and stretching properties. The lower the calcium/protein ratio is in the pasta filata cheese, the more melt and stretch can be obtained.

Therefore, prior art describes various method of removing calcium from a milk feed such that a pasta filata cheese with improved functionalities can be obtained.

However, when removing the calcium, pasta filata cheeses are obtained that have a decreased nutritional composition. When calcium is removed, the calcium content will be lower than for example the calcium content of a traditionally prepared pasta filata cheese obtained by acidifying and culturing a starting milk. This is a disadvantage since calcium plays an important role in many functions of the human body.

Hence, an improved method of preparing pasta filata cheese within a short period of time (without maturation) that have good functional properties, but does not have a reduced calcium content as compared to the milk derived feed used for preparing the cheese would be advantageous.

### SUMMARY OF THE INVENTION

Thus, an object of the present invention relates to providing a method of preparing a pasta filata cheese without maturation of the cheese where the functional properties of the pasta filata cheese is good while the calcium content is not reduced as compared to the calcium content in a traditional prepared pasta filata cheese.

In particular, it is an object of the present invention to provide a method of preparing a pasta filata cheese that solves the above mentioned problems of the prior art.

Thus, one aspect of the invention relates to a method of preparing a pasta filata cheese, wherein the method comprises the following steps:
i) providing a milk derived feed;
ii) subjecting the milk derived feed to ultrafiltration (UF) with an ultrafiltration membrane to provide a UF permeate and a UF retentate;
iii) adding one or more coagulating enzymes(s) to the UF retentate to obtain a mixture;
iv) heating the mixture of step iii) to a temperature in the range of 25° C. to 60° C. for a time period sufficient to coagulate the mixture and obtain cheese curd and whey;
v) separating the whey from the cheese curd;
vi) adding calcium to the cheese curd to obtain a calcium enriched cheese curd;
vii) subjecting the calcium enriched cheese curd of step vi) to heating and stretching to obtain a pasta filata cheese.

Another aspect of the present invention relates to a pasta filata cheese obtainable by the method according to any of the claims 1 to 12.

Yet another aspect of the present invention is to provide a pasta filata cheese, wherein the pasta filata cheese comprises:
i) a total calcium content in an amount of at least 0.35% by weight;
ii) bound calcium in an amount of at least 65% by weight of the total calcium content.

### BRIEF DESCRIPTION OF THE FIGURES

FIG. 1 shows colour, oiling, stretch, melt, and texture of two mozzarellas according of the invention (A3 and A4) as compared to a traditionally prepared mozzarella with maturation (A1) and without maturation (A5) and a mozzarella prepared in 24 hours but without addition of calcium (A2).

FIG. 2 shows the content of total calcium and the content of bound calcium in a mozzarella according to the invention (A3) as compared to a traditionally prepared mozzarella with maturation (A6).

The present invention will now be described in more detail in the following.

### DETAILED DESCRIPTION OF THE INVENTION

### Definitions

Prior to discussing the present invention in further details, the following terms and conventions will first be defined:

All references to singular characteristics or limitations of the present invention shall include the corresponding plural characteristics or limitations, and vice versa, unless otherwise specified or clearly implied to the contrary by the context in which the reference is made.

All percentages referred to herein are percentages by weight unless otherwise stated. The term “w/w” also refers to weight percentage. For example, 1% w/w refers to a composition comprising 1% by weight of a compound.

In the method according to the present invention, calcium is first removed from a milk derived feed used for preparing a pasta filata cheese. Removal of the calcium from the milk derived feed will result in improved properties of the pasta filata cheese, such as improved melting properties, stretching and browning of the cheese during baking/heating. The calcium is removed by an ultrafiltration step of the method of the invention. However, it was surprisingly found by the inventors of the present invention that calcium could be added to cheese curd having a low calcium content before or during the cheese curd are processed into a pasta filata cheese without reducing the good properties obtained by removing calcium before processed into curd.

This makes it possible to make pasta filata cheeses in a short period of time, and without maturation, that have very good functional properties, i.e. have good browning, melting and stretching properties, but without the calcium content being reduced.

It is an advantage to be able to make a pasta filata cheese without maturation that does not have a reduced calcium content in order to obtain a beneficial nutritional composition. The pasta filata cheese is expected to be more healthy and have an increased nutritional value if the calcium content is closer to the natural occurring calcium content.

It is known that removal of calcium from a milk derived feed in the processing of cheese curd results in improved functional properties of a pasta filata cheese.

However, it was very surprising for the inventors of the present invention that the same good functional properties of the pasta filata cheese was maintained when adding calcium to the cheese curd that earlier have had calcium removed. Without being bound by any theory, the inventors of the present invention believe that this is due to the balance between bound calcium and free calcium is changed when bound calcium is first being removed from the milk derived feed, and then calcium is added to the cheese curds later in the process.

Calcium is an important nutrient that the human body needs for many basic functions. For example, humans need calcium for building up and maintaining strong bones and teeth. Further, calcium plays a role in making muscles to move and for nerves to carry messages between the brain and every part of the body. Calcium also helps blood vessels move blood throughout the body and helps release hormones that affect many functions in the body. The human body does not produce calcium and therefore calcium is only applied to the human body through the calcium present in the diet. Hence, it is beneficial to keep the calcium content in a pasta filata cheese as high as possible.

Hence, an important and essential feature of the method according to the present invention is addition of calcium to cheese curd obtained from a milk derived feed wherefrom calcium has earlier been removed, such that a calcium enriched cheese curd is obtained (step vi) of the method of the invention). Said calcium enriched cheese curd is subjected to heating and stretching to obtain the pasta filata cheese of the invention.

In a preferred embodiment of the present invention, the calcium added to the cheese curd in step vi) is calcium citrate. When adding calcium citrate, the pasta filata cheese processed from the cheese curd will besides from having an increased calcium content and without decreasing the good functional properties of initially removing calcium, also result in a pasta filata cheese that appears more white and can appear less transparent.

In an embodiment of the invention, calcium added in step vi) of the method of the invention is obtained from a liquid dairy stream comprising citric acid and/or citrate. The calcium is then present in the liquid dairy stream as calcium citrate. Preferably, the pH of such liquid dairy stream comprising calcium citrate is in the range of 5.0 to 6.2, preferably a pH in the range of 5.2 to 6.0, more preferably in the range of 5.5 to 6.0.

The term “liquid dairy stream” refers in the context of the present invention to a stream or fraction obtained from membrane filtration of a dairy liquid product. In an embodiment of the present invention, the liquid dairy stream is selected from the group consisting of whey, ultrafiltration permeate, microfiltration permeate, whey protein concentration and a combination thereof.

The ultrafiltration permeate is typically a permeate stream obtained by ultrafiltration of a liquid dairy milk product. For example, the ultrafiltration permeate can be a permeate stream obtained by ultrafiltration of milk. The ultrafiltration permeate may also be the permeate obtained after ultrafiltration of whey in connection with production of cheese curd.

The microfiltration permeate is typically a permeate stream obtained by microfiltration of a liquid dairy milk product. For example, the microfiltration permeate can be a permeate obtained by microfiltration of milk, said microfiltration permeate may be referred to as a milk serum protein concentrate. In the context of the present invention, the terms “milk serum protein” or “serum protein” refer to the protein found in the milk serum. The milk serum proteins typically include beta-lactoglobulin, alpha-lactalbumin, bovine serum albumin, immunoglobulin and osteopontin as well as lactoferrin and lactoperoxidase. The milk serum protein may furthermore contain a significant amount of beta-casein when the milk feed has been stored at low temperature (4° C.) without it being subsequently heat-treated.

The term “whey” refers to the liquid obtained after casein is precipitated and strained from the milk.

The liquid dairy stream typically comprises other minerals than calcium, such as potassium, magnesium, sodium, phosphorous. The liquid dairy stream typically also comprises lactose, for example 20-30% of the dry matter content. Protein will be present in very low amounts in the liquid dairy stream, such as in amounts of 3% or less of the dry matter content, and preferably 2% or less of the dry matter content.

In another preferred embodiment of the invention, calcium, in particular calcium citrate, is added to the cheese curd before or during the heating and stretching in step vi) of the method of the invention. Typically, the heating and stretching of the cheese curd is made in a cooker stretcher. Any type of cooker stretcher known by the skilled person could be used for preparing the pasta filata cheese.

Calcium and other ingredients used in the preparation of the pasta filata cheese is preferably mixed before heating and stretching. Typically, all ingredients are mixed with the cheese curd in the cooker stretcher before heating. Alternatively, the calcium and other ingredients are mixed with the cheese curd during heating, but if so, the mixing has to be before the temperature of the heating step reaches 64° C. At temperatures of 64° C. or above, the stretching of the mixture begins. It is desired to add calcium to the cheese curd before stretching initiates. In preferred embodiments of the invention, calcium is mixed with the cheese curd during the heating step, but where the heating is at a temperature below 60° C., such as below 50° C., preferably below 45° C.

Calcium is typically added to the cheese curd in an amount such that the calcium content is in an amount at least corresponding to the calcium content in a traditionally prepared mozzarella including a maturation step.

In an embodiment of the present invention, calcium is added to the cheese curd in step vi) in an amount of 0.10% to 1.0% by weight per 100 kg of the calcium enriched cheese curd. Preferably, calcium is added to the cheese curd in step vi) in an amount of 0.15% to 0.7% by weight per 100 kg of the calcium enriches cheese curds, more preferably 0.2% to 0.5%, 0.10% to 1.0% per 100 kg curd corresponds to a calcium content in the pasta filata cheese being in the range of 0.055% to 0.55% by weight.

In an embodiment of the method of the present invention, one or more further ingredient may be added to the calcium enriched cheese curd of step vi) before or during heating and stretching in step vi). The one or more further ingredient is preferably selected from the group consisting of minerals, acids, fat and water.

The fat may be any vegetable or animal fat suitable for use in preparing a pasta filata cheese. The fat is preferably dairy cream. However, the fat may also be vegetable fat or oil, such as palm oil, rapeseed oil, sunflower oil and other vegetable oil suitable for preparing a pasta filata cheese.

The amount of fat added to the calcium enriched cheese curd should not be seen as a limitation of the present invention. For example, pasta filata cheese can be made with a high fat content and with a low fat content. However, as an example, fat may be added in an amount such that a fat content in the pasta filata cheese is 10% to 30% by weight, preferably 18% to 25% by weight.

Water is typically added in an amount of 2% to 10% by weight, preferably 3% to 8%, more preferably 4% to 5%. Moisture can be added directly by adding water but may also be added as steam in the heating step. Water is typically added in an amount to obtain a moisture content of the pasta filata cheese in the range of 50% to 60% by weight.

Any food grad acid may be added to the calcium enriched cheese curd when processing into a pasta filata cheese. The acid added is typically lactic acid, citric acid, acetic acid, malic acid, or glucono delta-lactone, preferably, lactic acid, citric acid or acetic acid. The acid is preferably lactic acid, and acid is typically added in an amount of 0.1% to 0.5% by weight. Addition of acid is made in order to adjust the pH of the pasta filata cheese. Furthermore, addition of acid has an inhibiting effect on growth of microorganisms and bacteria and may therefore contribute to increased storage time of the pasta filata cheese. Lactic acid is preferred since lactic acid has a higher inhibitory effect than for example citric acid. Further, lactic acid does not have any off-taste which some other acids may have.

The mineral added to the calcium enriched cheese curd is typically sodium chloride and/or potassium chloride, but other minerals and salt may be added. Minerals are typically added in an amount of 0.5% to 2.0% by weight.

### Milk Derived Feed:

The milk derived feed used for preparing the pasta filata cheese of the present invention may be based on milk from mammals, such as cows, buffalos, goats, sheep, yaks, pigs, horses, ewes, mares, or mixtures thereof. In a preferred embodiment of the present invention, the milk derived feed is from cows or buffalos, and in a more preferred embodiment, the milk derived feed is from cows, i.e. bovine milk. The term bovine milk and cow's milk refer to the same.

The milk derived feed used may in an embodiment of the invention be selected from the group consisting of whole milk, low-fat milk, reduced fat milk, fat-free milk, reconstituted milk powder, heat treated milk (e.g. pasterurised milk, and UHT milk), raw unfiltered milk, homogenised milk, whey protein reduced milk, micellar casein isolate, micellar casein concentrate, and combinations thereof.

In a further preferred embodiment of the invention, the milk derived feed is pasteurised milk, and especially pasteurised bovine milk. When referring to pasteurised milk, it may in principle be any type of the above mentioned milk products that have been pasteurised, such as pasteurised whole milk, low-fat milk, reduced fat milk, fat-free milk, raw unfiltered milk, homogenised milk, whey protein reduced milk, micellar casein isolate, and micellar casein concentrate. Further, in a preferred embodiment, the milk derived feed is a milk feed where fat is partly or fully removed, such as low-fat milk, reduced fat milk, or fat-free milk. It is preferred that the fat content of the milk derived feed has been removed or at least partly removed from milk before further processing, since fat in the milk derived feed will lower the filtration capacity during the ultrafiltration at cold temperatures. In the method of the present invention, it is preferred to avoid loss of fat during the ultrafiltration step. Fat is typically added later in the process of preparing the pasta filata cheese to the cheese curd before or during the heating and stretching process. Preferably, the milk derived feed is selected from the group consisting of pasteurised low-fat milk, pasteurised reduced fat milk and pasteurised fat-free milk.

In a preferred embodiment of the invention, the milk derived feed is a combination of two or more of whole milk, low-fat milk, reduced fat milk, fat-free milk, reconstituted milk powder, heat treated milk, raw unfiltered milk, homogenised milk, whey protein reduced milk, micellar casein isolate, micellar casein concentrate, such as for example a combination of fat-free milk and a micellar casein isolate.

The fat in the milk derived feed (the milk used for preparing the pasta filata cheese) may be removed by a process known as fat standardisation. Traditionally, standardisation of milk has been achieved by removing nearly all the fat (cream) from the starting milk (by a separation technique) and adding back a known amount of cream (milk fat) thereto to achieve a predetermined protein/fat ratio in the milk. Fat standardisation is typically performed by subjecting the milk to centrifugation which separates the cream fraction from the skim milk fraction (reduced fat milk fraction).

In a preferred embodiment of the present invention, the milk derived feed comprises fat in an amount of 0.1% by weight or less. Preferably, the milk derived feed comprises fat in an amount of 0.05% by weight or less.

The milk derived feed comprises milk proteins including both casein and milk serum protein.

The casein in the milk derived feed is primarily present in the form of casein micelles, similar or even identical to the casein micelles found in e.g. skimmed milk.

The term “milk serum” refers to the liquid phase of milk in which casein micelles and milk fat globules are dispersed.

In the context of the present invention, the terms “milk serum protein” or “serum protein” refer to the protein found in the milk serum. The milk serum proteins typically include beta-lactoglobulin, alpha-lactalbumin, bovine serum albumin, immunoglobulin and osteopontin as well as lactoferrin and lactoperoxidase. The milk serum protein may furthermore contain a significant amount of beta-casein when the milk feed has been stored at low temperature without it being subsequently heat treated.

The term “protein” refers in the context of the present invention to polypeptides containing at least 10 amino acids and encompasses both single polypeptides and aggregates of polypeptides.

The term “non-protein nitrogen” (NPN) refers to nitrogen found in molecules that are not protein. In milk, a significant portion of the NPN contains urea. Ammonium salts and small peptides containing less than 10 amino acids.

The term “whey” refers to the liquid obtained after casein is precipitated in milk. In the present invention, precipitation of casein is obtained by using a coagulation enzyme, for example rennet. In other methods known in the art, the coagulation is due to acidification or a combination of acidification and addition of coagulation enzymes. The whey obtained from precipitation of casein by use of a coagulation enzyme is typically referred to as sweet whey, and the whey obtained from acid precipitation of casein micelles is typically referred to as acid whey or sour whey.

Where acid whey has limited use, the sweet whey can be further processed into various products, e.g. whey protein products or lactose products.

The term “cheese curd” refers to cheese particles obtained after coagulation of caseins in a milk derived feed.

In some embodiments of the invention, the milk serum protein of the milk derived feed is present in undenatured, native form, i.e. the same form as in raw milk, which has not been subjected to a denaturing heat treatment. It is therefore also preferred that the milk derived feed and the product stream from which the milk feed has been derived have not been subjected to conditions that have resulted in significant protein denaturation, such as e.g. high temperature for prolonged durations. However, the milk derived feed may be pasteurised. Pasteurisation of the milk derived feed may take place under standard conditions, namely, heat treatment of the milk derived feed at a temperature and time sufficient to kill pathogens, typically at 72° C. for 15 seconds.

In an embodiment of the invention, the milk derived feed comprises a total amount of protein in the range of 1-10% (w/w). Preferably, the milk derived feed comprises a total amount of protein in the range of 2-8% (w/w), and, even more preferably, the milk derived feed comprises a total amount of protein in the range of 3-5% (w/w), such as 3.0-4.6% (w/w).

The milk derived feed typically has a ratio between caseins and milk serum proteins (whey proteins) in the range of 70:30 to 90:10, such as for example in the range of 75:25 to 85:15, and typically in the range of 77:23 to 83:17.

The solid content of the milk derived feed may vary depending on the feed used, but the solid content is typically in the range of 1-30% (w/w). Preferably, the solid content of the milk derived feed is in the range of 4-25% (w/w). Even more preferably, the solid content of the milk derived feed is in the range of 5-15% (w/w).

In an embodiment of the present invention, the milk derived feed is an organic milk derived feed derived from an organic milk source. In a preferred embodiment of the invention, the milk derived feed is an organic skimmed milk.

In the context of the present invention, the term “organic milk” refers to milk produced by mammals, such as cattle, raised according to the following: the cattle must have free access to certified organic pasture for the entire gracing season. This period is specific to the farm's geographical climate but must be at least 120 days per year and preferably at least 150 days. Due to the weather, season, or climate, the grazing season may or may not be continuous. Organic cattle diets must contain at least 30 precent dry matter (on average) from certified organic pasture. Dry matter intake (DMI) is the amount of feed an animal consumes per day on moisture-free basis. The rest of its diet must also be certified organic, including hay, grain, and other agricultural products. The livestock should be managed without antibiotics, added growth hormones, mammalian or avian by-products, or other prohibited feed ingredients (e.g. urea or arsenic compounds).

In an embodiment of the invention, the temperature of the milk derived feed is, or is adjusted to be, in the range of 2° C. to 15° C. At temperatures in this range, the removal of calcium and the mineral balance during ultrafiltration is improved. At temperatures in the range of 2° C. to 15° C., preferably 4° C. to 10° C., beta-casein in casein micelles is dissolved and the casein micelles are disturbed such that calcium will leach out.

### Ultrafiltration:

The milk derived feed is, in step ii) of the method of the invention, subjected to ultrafiltration (UF) with an ultrafiltration membrane to provide a UF permeate and a UF retentate.

Preferably, the ultrafiltration in step ii) is carried out to obtain a protein content in the UF retentate of at least 7% by weight, more preferably at least 8% by weight and most preferably at least 10% by weight and even more preferably at least 12% by weight.

The ultrafiltration step will concentrate proteins in the UF retentate, but reduce the calcium content in the UF retentate, since some calcium will be lost in the UF permeate. It is important with the ultrafiltration step to increase the protein to calcium ratio in the milk derived feed.

In a preferred embodiment of the invention, the ultrafiltration is in combination with diafiltration. The diafiltration is also with an ultrafiltration membrane. The combination of ultrafiltration and diafiltration reduces the calcium level in the milk derived feed even further, The ultrafiltration will remove some calcium, while the combination of ultrafiltration and diafiltration will remove more calcium, and hence have an increased effect on calcium removal. The combination of ultrafiltration and diafiltration will therefore increase the protein to calcium ratio further as compared to whey using ultrafiltration alone. A reduced calcium content leads to cheese curd that when processed into cheese will have good functional properties. For example, by removing calcium from the milk derived feed, a pasta filata cheese is obtained having good melting properties, increased stretching, and less browning is obtained.

In an embodiment of the invention, the ultrafiltration is performed such that the protein content in the UF retentate is in the range of 7 to 25% by weight, more preferably 7 to 23% by weight and even more preferably in the range of 10 to 21% by weight.

If diafiltration is performed in combination with ultrafiltration, the diafiltration retentate obtained will comprise about the same protein content as the ultrafiltration retentate, but the calcium content is reduced.

Hence, if diafiltration is performed on the UF retentate, the diafiltration retentate obtained will comprise a total amount of protein of at least 7% by weight.

Further, if diafiltration is performed in combination with ultrafiltration, the one or more coagulating enzyme(s) added in step iii) of the method of the invention is added to the diafiltration retentate, and the mixture is obtained from the diafiltration retentate and coagulating enzyme(s).

Preferably, the amount of total protein in the diafiltration retentate will be in the range of 7 to 25% by weight, such as 7 to 23% by weight, more preferably 10 to 21%.

The ultrafiltration membrane used for ultrafiltration and diafiltration may be the same of different membranes. The membrane used for ultrafiltration and diafiltration is typically the same. The UF membrane allows passage of small peptides, minerals and some lactose into the permeate while retaining the milk serum protein, micellar casein, dissolved beta-casein and some lactose.

Approximately, 50% of the lactose in the milk derived feed will be retained in the retentate while approximately 50% penetrates the UF membrane and is present in the permeate.

According to an embodiment, the cut-off of the ultrafiltration membrane used for the ultrafiltration membrane and optionally for the diafiltration is in the range of 2000 Da to 50000 Da, preferably 2500 to 30000 Da, and more preferably about 20000 Da. In a preferred embodiment of the invention, a polymeric membrane is used having a molecular weight cut-off of 20000 Da.

The ratio between the casein and milk serum protein will after ultrafiltration and optionally diafiltration be the same as for the milk derived feed used.

The concentration factor (CF) of the ultrafiltration step may for example be in the range of 2.0 to 7.1. Preferably, the concentration factor is in the range of 2.5 to 6, and even more preferably in the range of 3.0 to 5.1. A concentration factor in the range of 2.0 to 7.1 corresponds to obtaining a protein content in the ultrafiltration retentate in the range of 7% to 25% by weight. Further, a concentration factor in the range of 3.0 to 5.1 corresponds to obtaining a protein content in the ultrafiltration retentate in the range of 10.5% to 18% by weight.

The concentration factor of the diafiltration step is in an embodiment of the invention in the range of 1.1 to 7.5.

The concentration factor is defined as the weight ratio between the protein content in the liquid milk derived feed to the protein content in the retentate obtained. Hence, if the concentration factor is 3, the protein content in the UF retentate has been concentrated 3 times as compared to the protein content in the milk derived feed. Hence, if the milk derived feed has a protein content of 3.5% by weight and a CF of 3, the protein content in the UF retentate is (3.5×3) 10.5% by weight.

The calcium content in the UF or DF retentate is reduced up to 50% by weight as compared to the calcium content in the milk derived feed. The amount of calcium removed is dependent on the concentration factor. The amount of calcium removed during the ultrafiltration and optionally diafiltration as compared to the calcium content in the milk derived feed is in the range of 30% to 50% by weight.

For the present invention, it is important to remove calcium from the milk derived feed because the functional properties of the obtained pasta filata cheese is improved when calcium is removed before the cheese curd are obtained. The calcium removed from the milk derived feed will both be free calcium and calcium bound to the casein micelles.

However, it is also important that calcium is not totally removed since if more than 50% by weight calcium is removed, no gelation occur and cheese curd cannot be formed. If too much calcium is removed, the casein micelles are turned to soluble caseins having no functionality.

The calcium content can be measured by any method available for the skilled person, such as X-ray fluorescence spectroscopy or ion chromatography.

The calcium content is in example 1 measured using X-ray fluorescence spectroscopy from Rigaku Ltd.

The calcium content (total calcium and bound calcium) in example 3 is measured using ion chromatography. Dionex-ICS-5000 was used.

Free calcium is measured using centrifugation. The calcium is the calcium obtained in the supernatant after centrifugation. The free calcium is measured of the supernatant using ion chromatography (IC).

Bound calcium is measured by using centrifugation. The pellet after centrifugation is redissolved in the same volume water as the volume of the supernatant. The bound calcium is measured using ion chromatography.

If a fat-free milk (skim milk) is used as the milk derived feed, the calcium content will typically be about 1000-1400 mg/kg and the protein content 35 g/kg. This corresponds to a calcium content of 1-1.4 g per 35 g protein (in 1 kg milk) which is equal to 0.028-0.040 g calcium per g protein. After ultrafiltration to a 10% protein content in the UF retentate, i.e. a concentration factor of 2.85 (10/3.5), the calcium content in the UF retentate will be about 2138 to 2992 mg/kg. This corresponds to a calcium content of 0.021 to 0.030 g calcium per gram protein. After ultrafiltration and diafiltration, the calcium content is reduced to 1600 to 2250 mg/kg. This corresponds to 0.0160 to 0.0225 g calcium per g protein. Hence, after both ultrafiltration and diafiltration (to a 10% protein content), the calcium content per gram protein is reduced with about 40-43% as compared to skim milk.

The UF retentate or DF retentate obtained may in an embodiment of the invention be diluted with a liquid to obtain a diluted UF retentate or diluted DF retentate having a protein content of 5-18% by weight. The protein content is measured using the FoodScan™ Dairy analyser using near infrared transmission technology (NIT).

In a preferred embodiment of the invention, the milk derived feed is subjected to ultrafiltration to obtain a protein content in the retentate of at least 18% by weight and the UF retentate is subjected to dilution to a protein content of 5-18% by weight before further processing.

Useful, but not limiting, examples of diluents which can be used for diluting of the UF retentate or the DF retentate are demineralised water or reverse osmosis (RO) water. The demineralised water may also be referred to as distilled water. The RO water refers in the context of the present invention to any permeate from membrane filtration of milk and tap water that has been subjected to reverse osmosis. Hence, RO water may be a permeate obtained by reverse osmosis of a permeate from ultrafiltration of milk, reverse osmosis of a permeate from nanofiltration of milk, or reverse osmosis of tap water.

In a preferred embodiment of the invention, the UF retentate (and optionally DF retentate) is diluted with RO water to obtain a content of total protein of 5% to 18% by weight, preferably 8 to 12% by weight.

In an embodiment of the invention, the temperature during the ultrafiltration and optionally the diafiltration step is in the range of 2° C. to 15° C.

### Removal of Calcium by Adding Acid or Calcium Chelating Agent

As mentioned above calcium is removed from the milk derived feed by the ultrafiltration step. However, larger amounts of calcium can be removed if the milk derived feed for example is added a food grade acid or a food grade calcium chelating agent before ultrafiltration in step ii). Removal of calcium lead to improved properties of the pasta filata cheese obtained.

Hence, in an embodiment of the present invention the method comprises that one or more food grade acid and/or one of more food grade calcium chelating agent is added to the milk derived feed of step i) before ultrafiltration in step ii).

When adding a food grade acid and/or a food grade calcium chelating agent to the milk derived feed more bound calcium will be released from the casein micelles and hence removed in the following ultrafiltration step.

The term “food grade acid” refers in the context of the present invention to an acid suitable for human consumption. Food grade acids may also be referred to as edible acids, and the terms are used interchangeably herein. Examples of food grade acids are for example organic acids, such as lactic acid, citric acid, acetic acid, malic acid, tartaric acid, oxalic acid, tannic acid, phosphoric acid, sulphuric acid, glucono delta lactone (GDL) and acid producing microorganisms.

Phosphoric acid and sulphuric acid may be used, but is not optimal to use since they provide an off-taste and is hard on the equipment used, for example it can corrode the metal. Preferably, the food grade acid is selected from the group consisting of acetic acid, citric acid, acetic acid, malic acid, tartaric acid, oxalic acid, tannic acid and acid producing microorganisms. More preferably, the food grade acid is one or more selected from the group consisting of citric acid, lactic acid and acetic acid, and most preferably, citric acid is used as food grade acid and added to the milk derived feed before ultrafiltration.

When one or more acids are added to the milk derived feed, the acid will solubilize the calcium in the milk derived feed, such that calcium more easily can be removed during the ultrafiltration step.

If a food grade acid is added to the milk derived feed before ultrafiltration, it is preferably to obtain a pH of the milk derived feed in the range milk product to 5.0 to 6.2, preferably 5.0-6.0

By the term “food grade calcium chelating agent” is in the context of the present invention referred to a calcium chelating agent suitable for use in preparing foods for human consumption. Furthermore, the term calcium chelating agent may also be referred to as a calcium chelator and the terms may be used interchangeable.

In the context of the present invention, the term calcium chelating agent refers to what is normally understood by a calcium chelating agent, i.e. a compound that forms very strong bonds to divalent metal ions (M²⁺), i.e. Ca²⁺, forming a complex.

The action of the food grade calcium chelating agent is therefore different than the action of the food grade acid. The calcium chelating agent will bind calcium in the milk derived feed, such that calcium more easily can be removed during the ultrafiltration step.

In principle, any type of food grade calcium chelating agent may be used for the present invention. However, in a preferred embodiment, the food grade calcium chelating agent is selected form the group consisting from ethylenediaminetetraacetic acid (EDTA), calcium disodium ethylenediaminetetraacetic acid (calcium disodium EDTA), disodium ethylenediaminetetraacetic acid (disodium EDTA), (monohydroxyethyl) ethylenediaminetetraacetic acid, (dihydroxyethyl)ethylenediaminetetraacetic acid and any other chelating agent capable of binding calcium.

Preferably, the food grade calcium chelating agent is selected from the group consisting of ethylenediaminetetraacetic acid (EDTA), calcium disodium ethylenediaminetetraacetic acid (calcium disodium EDTA), and disodium ethylenediaminetetraacetic acid (disodium EDTA). At neutral or alkaline pH, EDTA reacts with the calcium ion to form the highly water-soluble calcium-EDTA complex, CaEDTA.

The concentration of the food grade acid and/or food grade calcium chelating agent in the milk derived feed is typically at least 0.5% by weight, preferably in the amount of at least 1.0% by weight. Typically, the concentration of the calcium chelating agent in the milk derived feed is in the range of 0.5 to 10% by weight, such as in the range of 1 to 8% by weight, and preferably, the concentration of the calcium chelating agent in the milk derived feed is in the range of 2 to 6% by weight.

If a milk derived feed is added one or more food grade acid and/or food grade calcium chelating agent, the milk derived feed will after ultrafiltration to UF retentate having 10% protein content comprise 0.010 to 0.0225 g calcium per g protein. Hence, if one or more food grade acid and/or food grade calcium chelating agent is added the milk derived feed. The calcium content per gram protein in the UF retentate is reduced with about 40-43% as compared to skim milk.

### Addition of Coagulation Enzyme:

One or more coagulating enzyme(s) is/are added to the UF retentate. To obtain a mixture. Optionally, the one or more coagulating enzyme(s) can be added to a DF retentate, diluted UF retentate or diluted DF retentate.

The coagulating Enzym(s) is/are preferably added under stirring or mixing to distribute the enzyme(s) evenly throughout the UF retentate, diluted UF retentate, DF retentate or diluted DF retentate.

The coagulating enzymes may be any enzyme that has (kappa)-caseinolytic activity and that when used in an effective amount is capable of coagulating milk derived feeds such that cheese curd is obtained. For example, the coagulating enzyme may be rennet, chymosin, pepsin, microbial rennet, recombined rennet, any other suitable microbial or vegetable derived protease with caseinolytic activity or a combination thereof. A bacterially derived proteolytic enzyme (fermentation produced enzyme) may be Fromase® XL750 (DSM Food specialties, Herten, Netherlands) or ChyMax® (Christian Hansen A/S, Hørsholm, Denmark). Naturen® (Christian Hansen A/S, Hørsholm, Denmark) is an example of an animal rennet. One example of a suitable beneficial kappa-caseinolysis enzyme is an enzyme of vegetable origin, namely that obtained from the Card Cardosin. In a preferred embodiment of the invention, the coagulating enzyme(s) is any type of rennet and may therefore be selected from the group of rennet, microbial rennets and recombined rennets. In another preferred embodiment of the invention, the coagulating enzyme(s) comprises chymosin.

In an embodiment of the invention, the one or more coagulating enzyme(s) is rennet.

Rennet is a complex set of enzymes (when describing commercial products) produced in the stomach of ruminant mammals or produced by microorganisms. In the context of the present invention, the term “rennet” refers to rennet obtained from an animal stomach. Microbial rennet is obtained by fermentation by exposing certain microorganisms to rennet-producing genes from animals. Microbial rennet may also be referred to as vegetable rennet. The main enzyme in rennet is chymosin which is a protease enzyme cleaving the kappa casein chain. Cleavage causes casein to stick to other cleaved casein molecules and form a network, and hence curdles the casein in milk. The clustering of casein proteins is improved in the presence of calcium and phosphate, and therefore it is beneficial that some calcium is remained during production of the cheese curd. In addition to chymosin, rennet contains other enzymes such as pepsin and a lipase.

The coagulating enzyme, such as rennet, is typically added to the UF retentate in an amount of 5 ml/100 kg liquid to 50 ml/100 kg liquid when having an activity of 200-600 IMCU/ml. IMCU stands for International Milk Clotting Unit as defined in International Standard ISO 11815 (2207).

### Coagulation and Formation of Cheese Curd:

The UF retentate (and optionally diluted UF retentate, DF retentate or diluted DF retentate) is, after adding the coagulating enzyme(s) heated to a temperature in the range of 25° C. to 60° C. for a time period sufficient to coagulate the mixture and obtain cheese curds and whey. The cheese curd is afterwards separated from the whey.

Preferably, the heating during the coagulating step is at a temperature of 35° C. to 55° C. and most preferably at a temperature of 40° C. to 50° C. Coagulation is initiated when the temperature is above 15° C. However, at 15°, the speed of coagulation is very low. Hence, the temperature during the coagulation step should be above 25° C. for efficient coagulation. At temperatures above 40° C., coagulation proceeds very rapidly within seconds and almost instantly. A temperature above 40° C. is therefore preferred.

Further, the temperature during the coagulation step should not exceed 60° C., since at a temperature above 60° C. unwanted sticking of the obtained cheese curd occurs. Furthermore, the cheese curd begin to stretch at high temperatures which is wished avoided at this point in the process.

The time period of the coagulation step may vary a lot since the time required for coagulation is dependent on the temperature. Hence, at a temperature of 25° C., coagulation takes some time and the time period may therefore be several minutes and up to 60 minutes for efficient coagulation. However, if the temperature is 40° C. to 60° C., the time period for coagulation is within seconds (0.1-10 seconds) and may be instantly. At temperatures above 40° C., the coagulation starts instantly. The coagulation continues and complete coagulation is probably after 10-30 seconds. Hence, the time period for the coagulation step should not be seen as any limitation of the present invention. However, typically the time period for the coagulation is 0.1 second to 60 minutes.

Preferably, the mixture of UF retentate mixed with the coagulating enzyme(s) is stirred during the coagulation step to induce controlled turbulence in the solution to cause coagulation of the protein into small curd particles within the solution. The liquid obtained after obtaining curd particles is called whey. In step v) of the method of the present invention, whey is separated from the cheese curd.

The heating is typically by using direct or indirect heating means to coagulate the protein and form the coagulated curd particles. In case of direct heating, steam can be injected into the flow of the liquid UF retentate. In case of indirect heating, a jacketed heater or heat exchanger is associated with the flow path along which the liquid is being pumped. The temperature is increased to an upper limit which will be consistent with the parameters of the process, for example up to 55° C. and the flow rate is high causing controlled substantial turbulent into the liquid being passed there along. This prevents any large build up of curd and means that the protein coagulates into small curd particles.

The coagulated cheese curd (curd particles) may be separated from the whey by use of a separator, such as for example a decanter, a sieve, a filter or other means suitable for separating curd from whey. The whey will comprise some calcium that has not been removed earlier during the ultrafiltration (and optionally diafiltration) step. However, some calcium is maintained in the cheese curd.

In a non-limiting embodiment of the invention, the temperature of the UF retentate, and optionally the temperature of the diluted UF retentate, DF retentate or dilute DF retentate, is adjusted to a temperature of 4° C. to 15° C. before one or more coagulation enzyme(s) is added in step iii) of the method of the invention. At temperatures below 4° C., the coagulating enzyme will not work efficiently and provide sufficiently hydrolysis. Furthermore, at temperatures above 15° C., the coagulation will initiate. This should be avoided at this stage. The warmer the mixture is, the faster the coagulation is. Preferably, the temperature is adjusted to a temperature of 5° C. to 10° C. to avoid spontaneous coagulation. If the temperature is in the range of more than 10° C. and up to 15° C., the coagulation enzyme is slightly active and there is a risk of coagulation being initiated which is wished avoided. However, at temperatures of more than 10° C. and up to 15° C., the activity of the coagulation enzyme is still very low. Hence, even though temperatures of more than 10° C. and up to 15° C. are not optimal, the method can be carried out by adjusting the temperature to be in the range of 4° C. to 15° C. before adding the coagulation enzyme.

### Pasta Filata Cheese:

An aspect of the present invention relates to a pasta filata cheese obtainable by the method of the invention.

The pasta filata cheese of the invention comprises calcium, and in an aspect of the invention, the pasta filata cheese comprises:
i) a total calcium content in an amount of at least 0.35% by weight;
ii) bound calcium in an amount of at least 65% by weight of the total calcium content.

Preferably, the pasta filata cheese of the invention comprises a total calcium content in an amount of at least 0.38% by weight, more preferably, at least 0.40% by weight.

In another embodiment of the invention, the pasta filata cheese comprises a total calcium in the range of 0.35% to 1.0% by weight, preferably in the range of 0.38% to 0.8% by weight, more preferably in the range of of 0.4% to 0.7% by weight, such as in the range of 0.40 to 0.6%.

In a further embodiment, the pasta filata cheese of the present invention comprises bound calcium in an amount of at least 67% by weight of the total calcium content.

In also an embodiment of the present invention, the pasta filata cheese has a pH in the range of 5.0 to 6.0, such as in the range of 5.2 to 5.8, preferably 5.4 to 5.8.

The calcium content, bound calcium and total calcium is preferably measured by using ion chromatography and is preferably measured in a sample having a pH in the range of 5.2 to 5.8, preferably 5.6.

In the pasta filata cheese obtained by the method of the invention, 15% to 45% calcium is removed in the ultrafiltration step and 15% to 45% calcium can be added later on in the process.

In an embodiment of the present invention, the pasta filata cheese comprises calcium citrate in an amount of 0.05% to 1.0% by weight of the pasta filata cheese, such as in an amount of 0.08% to 0.7% by weight and more preferably in an amount of 0.1% to 0.5% by weight.

The term “free calcium” refers to calcium that is not bound to for example protein complexes, such as casein micelles, while the term “bound calcium” refers to calcium bound in protein complexes, such as casein micelles.

It should be noted that embodiments and features described in the context of one of the aspects of the present invention also apply to the other aspects of the invention.

The invention will now be described in further details in the following non-limiting examples.

### EXAMPLES

### Example 1: Comparing Functional Properties of Different Cheeses

Example 1 compares the nutritional composition and functional properties of a mozzarella according to the present invention to other mozzarellas. The different mozzarellas compared are:
A1: A traditional prepared mozzarella (matured for 2-3 weeks) made without removal of calcium
A2: A mozzarella prepared by removing a part of the calcium from the milk used to prepare the mozzarella, but without adding calcium to the cheese curd
A3: A mozzarella prepared by removing a part of the calcium from the milk used to prepare the mozzarella, and with reintroducing 0.135% calcium to the cheese curd before heating and stretching into the mozzarella (mozzarella of the invention)
A4: A mozzarella prepared by removing a part of the calcium from the milk used to prepare the mozzarella, and with reintroducing 0.315% calcium to the cheese curd before heating and stretching into the mozzarella (mozzarella of the invention)
A5: A traditional prepared mozzarella as in A1, but without maturation

The traditional mozzarella A1 is prepared by:
i. Heating skimmed milk to a temperature in the range of 60 to 72° C. and
ii. Adjusting the pH by adding an acidifying agent (HCl) to pH 5.5-5.6, adding rennet and a starter culture such that the proteins denature and coagulate to form a solid curd;
iii. Cutting the curd into smaller pieces and stir to release whey. Whey is separated;
iv. The curd is heated and becomes shrink and form a firmer texture;
V. The curd is stretched and kneaded to form a smooth plastic texture;
vi. The stretched and kneaded curd is shaped into a form of interest;
vii. The formed mozzarella is matured for 2-3 weeks.

The Mozzarella A2 is prepared in 24 hours and does not require any maturation. The mozzarella A2 is prepared by:
i. Providing skimmed milk and add citric acid to adjust pH to be in the range of 5.5-6.2;
ii. Subjecting the pH adjusted skimmed milk to ultrafiltration with the ultrafiltration UFPHT spiral would membrane (DA60PP) supplied by Alfa Laval. The membrane has a cut-off value of 20.000 Da. Ultrafiltration was performed until the protein content in the UF retentate was 10% by weight;
iii. Rennet (ChyMax® from Christian Hansen A/S, Denmark) was added and the mixture heated to a temperature of about 45° C. for around 0.1 second to coagulate the mixture and obtain cheese curd and whey. The curd was separated from the whey;
iv. The curd is heated and kneaded with cream (35-35%), salt (1.2%), lactic acid (0.3%) and water (4-5%) to form a smooth elastic texture which are cooled and shaped into a form of interest.

The mozzarella A3 and A4 is prepared similarly to mozzarella A2, but the UF permeate obtained from step ii. is after being concentrated and heat treated added to the cheese curd. Said UF permeate comprises calcium citrate. The permeate from ultrafiltration is added in A3 reintroduce 0.135% calcium and in A4 to reintroduce 0.315% calcium. In A3, 3% of the ultrafiltration permeate is reintroduced corresponding to reintroducing 0.135% calcium. In A4 is 7% ultrafiltration permeate reintroduced corresponding to reintroducing 0.315% calcium.

The mozzarella A5 is prepared similarly to the mozzarella A1 but is not matured.

In table 1 below is the content of protein, fat, calcium and dry matter mentioned for the five mozzarellas compared (A1, A2, A3, A4 and A5). The calcium content was measured using X-ray fluorescence spectroscopy from Rigaku Ltd.

TABLE 1

| | Mozzarella | Mozzarella | Mozzarella | Mozzarella | Mozzarella |
|---|---|---|---|---|---|
| | A1 | A2 | A3 | A4 | A5 |
| Protein (%) | 22.4 | 20-22 | 20-22 | 20-22 | 22.4 |
| Fat (%) | 20.2-24.5 | 18-20 | 18-20 | 18-20 | 20.2-24.5 |
| Calcium (%) | 0.42 | 0.30 | 0.43 | 0.58 | 0.42 |
| Dry matter (%) | 46.0-51.0 | 43-45 | 43-45 | 43-45 | 46.0-51.0 |
| pH | 5.1-5.5 | 5.4-5.5 | 5.4-5.5 | 5.4-5.5 | 5.1-5.5 |

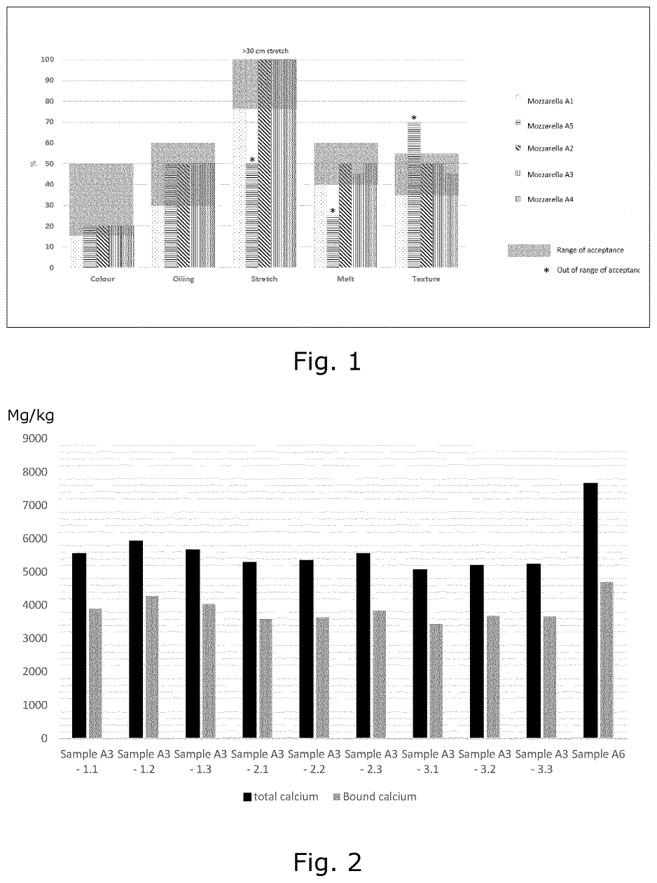

An extern sensory panel consisting of 10 panellists evaluated the functional properties of the five cheeses. The colour, oiling, stretch, melt and texture of the mozzarella cheeses A1-A5 was evaluated. The result is shown in FIG. 1.

From FIG. 1, it is shown that a mozzarella prepared by removing calcium of the milk derived feed and prepared by 24 hours has a colour, oiling, stretch, melt and texture similar to a traditionally prepared mozzarella that needs maturation for 2-3 weeks. Further, it was very surprisingly found by the inventors that the same functional properties were found of a mozzarella (A3 and A4) where calcium has first been removed and later reintroduced. Therefore, it was surprisingly found that it was possible to enrich pasta filata cheese with calcium, naturally, without decreasing the good functional properties that was first obtained by removing calcium.

Further, it was found by the inventors that the calcium content may actually be increased to a content that is higher than the calcium content in a traditionally prepared mozzarella without reducing the functional properties obtained by first removing calcium. A traditionally prepared mozzarella that is prepared without removing calcium (A1) from the feed before coagulation will have a calcium content about 0.42%. About 25% of said calcium is removed by the ultrafiltration step of the present method. However, by reintroducing the calcium to about 0.43% the functional properties are maintained and surprisingly the functional properties were also maintained when the calcium content was further increased to about 0.58%.

### Example 2: Example of an Ultrafiltration Permeate Comprising Calcium Citrate

Example 2 shows an example of a liquid dairy stream comprising calcium citrate. The liquid dairy stream is obtained by providing skimmed milk, adding citric acid to the skimmed milk to obtain a pH of 5.7 and subjecting the acidified skimmed milk to ultrafiltration (UF) with the ultrafiltration UFPHT spiral would membrane (DA60PP) supplied by Alfa Laval. The membrane has a cut-off value of 20.000 Da. After ultrafiltration, an UF permeate is obtained having the following composition shown in table 2:

TABLE 2

| | Content of | Content |
|---|---|---|
| | dry matter | in Slurry |
| | (%) | (%) |
| Calcium | 14.30 | 4.72 |
| Potassium | 1.20 | 0.40 |
| Magnesium | 0.17 | 0.06 |
| Sodium | 0.26 | 0.09 |
| Phosphorous | 1.09 | 0.36 |
| Ash | 39.30 | 12.97 |
| Citrate | 40.17 | 13.26 |
| Lactose | 27.19 | 8.97 |
| Protein | 1.59 | 0.52 |
| Dry matter | 98.64 | 32.55 |
| pH | 5.72 | |

By using a liquid dairy stream comprising calcium citrate for the reintroduction of calcium, it is possible to provide a pasta filata cheese with a calcium content originally coming from milk. This makes the mozzarella nutritionally better and it still keeps the same functional properties and sensory attributes.

### Example 3: Comparing the Calcium Content in a Traditional Prepared Mozzarella and a Mozzarella of the Present Invention

A cheese prepared as in sample A3 in example 1 was prepared. Hence, the cheese was prepared by first removing calcium from skim milk and after curd formation reintroducing the same amount of calcium as initially removed. This cheese is in example 3 also referred to as A3. 3 cheeses of the A3 type was prepared and from each cheese 3 samples was prepared and analysed for the amount of total calcium and the amount of bound calcium.

Further, the amount of total calcium and the amount of bound calcium was analysed for a traditional mozzarella. The traditional prepared mozzarella is referred to as A6.

The traditional mozzarella were of the same type as A1 but from a different dairy plant.

The traditional mozzarella A6 is prepared by:
i. Heating skimmed milk to a temperature of 72° C. for 15 seconds in a cheese vat; and
ii. Adding rennet and a starter culture such that the proteins denature and coagulate to form a solid curd,
iii. Cutting the curd into smaller pieces and stir to release whey. Whey is separated,
iv. The curd is heated and becomes shrink and form a firmer texture,
v. The curd is stretched and kneaded to form a smooth plastic texture,
vi. The stretched and kneaded curd is shaped into a form of interest,
vii. The formed mozzarella is cooled and matured for 2-3 weeks.

The traditional cheese A6 has the nutrient content as disclosed in table 3 below:

TABLE 3

| | Mozzarella |
|---|---|
| | A6 |
| Protein (%) | 25.09 |
| Fat (%) | 21.29 |
| Calcium (%) | 0.66 |
| Dry matter (%) | 52.06 |
| pH | 5.29 |

The calcium content (total calcium and bound calcium) in the samples was measured the following method:
1) 4 g of each cheese were weighed, and reverse osmosis water added at 55° C. to obtain a solution having a final weight of 40 g. The samples were homogenized using a T18 Ultra Turrax at 13,500 rpm for 30 seconds.
2) 1 ml of the homogenized sample was mixed with 0.5 ml 1M HCL and stirred
3) Afterwards, the samples were centrifuged at 10,000×g for 10 minutes and the supernatant was separated from the pellet.
4) The supernatant and the pellet of the samples were analysed in triplets for total calcium content and bound calcium content, where the bound calcium content is in the pellet and the total calcium content is the combined calcium content of the supernatant and the pellet.

The calcium content was measured using ion chromatography. A Dionex-ICS-5000 was used.

FIG. 2 shows the content of the bound calcium and the amount of total calcium in the different samples. The data in FIG. 2 is also shown in table 4 below. FIG. 4 also shows the percentage of bound calcium as compared to the total amount of calcium in each sample.

TABLE 4

| | Total | Bound | |
|---|---|---|---|
| | calcium | calcium | % |
| Sample | (mg/Kg) | (mg/kg) | Bound |
| A3 - 1.1 | 5544.9 | 3887.91 | 70.1 |
| A3 - 1.2 | 5917.6 | 4276.15 | 72.3 |
| A3 - 1.3 | 5652.4 | 4027.17 | 71.2 |
| A3 - 2.1 | 52.74.1 | 3582.27 | 67.9 |
| A3 - 2.2 | 5332.1 | 3637.99 | 68.2 |
| A3 - 2.3 | 5544.8 | 3837.28 | 69.2 |
| A3 - 3.1 | 5063.4 | 3434.60 | 67.8 |
| A3 - 3.2 | 5188.3 | 3672.07 | 70.8 |
| A3 - 3.3 | 5229.2 | 3650.29 | 69.8 |
| A6 | 7652.3 | 4693.88 | 61.3 |

Hence, from both FIG. 2 and table 4 it is shown that the content of bound calcium of the total calcium content in the cheese according to the present invention surprisingly was significantly higher than in the traditionally prepared cheese. This was a surprise since free calcium was removed in the whey drainage in the traditionally prepared cheese, while calcium citrate was added as free calcium to the cheese curd in the present invention. The inventors of the present invention believes, without being bound by any theory that this is because the free calcium added to the curd as calcium citrate will bind/make complexes.

1. A method of preparing a pasta filata cheese, comprising:
i) providing a milk derived feed;
ii) subjecting the milk derived feed to ultrafiltration (UF) with an ultrafiltration membrane to provide a UF permeate and a UF retentate;
iii) adding one or more coagulating enzymes(s) to the UF retentate to obtain a mixture;
iv) heating the mixture to a temperature in the range of 25° C. to 60° C. for a time period sufficient to coagulate the mixture and obtain cheese curd and whey;
v) separating the whey from the cheese curd;
vi) adding calcium to the cheese curd to obtain a calcium enriched cheese curd; and
vii) subjecting the calcium enriched cheese curd to heating and stretching to obtain a pasta filata cheese.

2-16. (canceled)

17. The method according to claim 1, wherein the calcium added is calcium citrate.

18. The method according to claim 1, wherein the calcium is added to the cheese curd before or during the heating and stretching.

19. The method according to claim 17, wherein the calcium citrate is obtained from a liquid dairy stream comprising citric acid and/or citrate.

20. The method according to claim 1, wherein calcium is added to the cheese curd in an amount of 0.10 to 0.5% by weight per 100 kg of the calcium enriched cheese curd.

21. The method of claim 1, wherein the UF retentate is further subjected to diafiltration (DF) with an ultrafiltration membrane to obtain a DF permeate and DF retentate and the mixture is obtained by adding one or more coagulation enzyme(s) to the DF retentate.

22. The method according to claim 1, wherein the milk derived feed is selected from the group consisting of whole milk, low-fat milk, reduced fat milk, fat-free milk, reconstituted milk powder, heat treated milk, raw unfiltered milk, homogenised milk, mineral reduced milk, whey protein reduced milk, micellar casein isolate, micellar casein concentrate, and combinations thereof.

23. The method according to claim 1, wherein one or more food grade acid and/or one or more food grade calcium chelating agent is added to the milk derived feed before ultrafiltration.

24. The method according to claim 23, wherein the one or more food grade acid is selected from the group consisting of lactic acid, citric acid, acetic acid, malic acid, tartaric acid, oxalic acid, tannic acid, phosphoric acid, sulphoric acid, glucono-delta-lactone, and an acid producing microorganism.

25. The method according to claim 23, wherein the one or more food grade calcium chelating agent is selected from the group consisting of ethylenediaminetetraacetic acid (EDTA), calcium disodium ethylenediaminetetraacetic acid (calcium disodium EDTA), disodium ethylenediaminetetraacetic acid (disodium EDTA), (monohydroxyethyl)ethylenediaminetetraacetic acid, (dihydroxyethyl)ethylenediaminetetraacetic acid and any other chelating agent capable of binding calcium.

26. The method according to claim 1, wherein the one or more coagulating enzymes(s) is rennet.

27. The method according to claim 1, wherein one or more further ingredient is added to the calcium enriched cheese curd before or during heating and stretching in a cooker stretcher.

28. The method according to claim 27, wherein the one or more further ingredient is selected from the group consisting of minerals, acids, fat and water.

29. A pasta filata cheese obtainable by the method according to claim 1.

30. The pasta filata cheese according to claim 29, wherein the pasta filata cheese comprises:
i) a total calcium content in an amount of at least 0.35% by weight; and
ii) bound calcium in an amount of at least 65% by weight of the total calcium content.

31. The pasta filata cheese according to claim 29, wherein the pasta filata cheese has a pH in the range of 5.0 to 6.0.
